(19) United States
(12) Patent Application Publication
(10) Pub. No.: US 2016/0246354 A1
(43) Pub. Date: Aug. 25, 2016

(54) REDUCING POWER FOR STORAGE DEVICES

(71) Applicant: HEWLETT-PACKARD DEVELOPMENT COMPANY, L.P., Houston, TX (US)

(72) Inventors: Shishir Misra, Bangalore (IN); Mandar Govind Nanivadekar, Bangalore (IN)

(21) Appl. No.: 14/764,717

(22) PCT Filed: Feb. 28, 2013
(86) PCT No.: PCT/US2013/028134

§ 371 Date: Jul. 30, 2015

(51) Int. Cl. G06F 1/32

(52) U.S. Cl. CPC G06F 1/3234; G06F 1/3228; G06F 11/1458

(57) ABSTRACT

Techniques for reducing power for storage devices are described in various implementations. An example method that implements the techniques may include determining a time period of inactivity during which backup operations are not scheduled to be performed on a storage device. The method may also include causing the storage device to enter a reduced-power state based on the determined time period of inactivity.

### BACKGROUND

Many companies place a high priority on the protection of data. In the business world, the data that a company collects and uses is often the company's most important asset, and even a relatively small loss of data or data outage may have a significant impact. In addition, companies are often required to safeguard their data in a manner that complies with various data protection regulations. As a result, many companies have made sizeable investments in data protection and data protection strategies.

As one part of a data protection strategy, many companies perform backups of portions or all of their data. Data backups may be executed on an as-needed basis, but more typically are scheduled to execute on a recurring basis (e.g., nightly, weekly, or the like). Such data backups may serve different purposes. For example, one purpose may be to allow for the recovery of data that has been lost or corrupted. Another purpose may be to allow for the recovery of data from an earlier time—e.g., to restore previous versions of files and/or to restore a last known good configuration.

### BRIEF DESCRIPTION OF THE DRAWINGS

FIG. 1 shows a conceptual diagram of an example backup environment in accordance with implementations described herein.

FIGS. 2A and 2B show block diagrams of example backup environments in accordance with implementations described herein.

FIG. 3 shows a conceptual diagram of an example backup schedule with determined time periods of inactivity in accordance with implementations described herein.

FIG. 4 shows a flow diagram of an example process for causing a storage device to enter a reduced-power state in accordance with implementations described herein.

FIG. 5 shows a block diagram of an example system in accordance with implementations described herein.

### DETAILED DESCRIPTION

A backup system may protect vital data, e.g., in a datacenter, by storing the backed up data in a persistent destination store. The destination store may include single or multiple storage devices of similar or disparate storage types, such as tape devices, tape libraries, or disk devices (local and/or network-based). Such destination stores may allow for the backup of large amounts of customer data that is backed up, e.g., from file systems, database servers, application servers, or the like.

Backup operations may be scheduled, e.g., by a backup administrator, to occur at a specific date and time. Backup operations may also be scheduled to occur on a periodic or recurring basis (e.g., daily, weekly, monthly, or the like). To minimize the impact on normal operations, backup operations are usually scheduled to occur during time periods when system usage is expected to be at its lowest, such as late in the evening or during the early morning hours.

Since most backup operations are scheduled to occur during off-peak hours, and since recovery operations are typically infrequent, storage devices in a datacenter may remain in an idle or inactive state for a large portion of most days. Even when idle or inactive, the storage devices may continue to consume relatively significant amounts of power. As an example, some disk-based storage devices may consume approximately 13.5 watts of power while idle. Tape libraries may consume even more power, often exceeding 100 watts of power while idle. Such power consumption by storage devices that are sitting idle for a large proportion of the time can significantly affect the power efficiency of a datacenter, especially considering the large numbers of storage devices used in a typical datacenter.

According to the techniques described here, a backup computing system may be used to reduce the power consumption of storage devices when they are not in use. To do so, the backup computing system may determine time periods of inactivity during which backup operations are not scheduled to be performed on the storage devices, either on an individual or a collective basis. In other words, the backup computing system may identify periods of time when the storage devices would otherwise be idle. During such periods of inactivity, the backup computing system may cause the storage devices to enter a reduced-power state. For example, the backup computing system may signal the storage devices, either directly or indirectly, to enter a lower-power consumption mode or to completely shut down.

As used herein, the terms “reduced-power” and “reduced-power state” may include a number of different possibilities, including a sleep state, a power-saving state, a hibernation state, a powered-off state, or a cut-power state, for example. It should be understood that such terms may also include other appropriate examples of “reduced-power” operation, and may generally be considered to include any power consumption model that consumes less power than when a storage device is operating in a normally-powered idle state.

The techniques described here may be used, for example, to improve the power efficiency of individual storage devices or groups of storage devices. The techniques may also be used to improve the power efficiency of datacenters and other facilities that utilize a number of storage devices. In some cases, such techniques may also extend the useful life (typically measured in hours of use) of storage devices. These and other possible benefits and advantages will be apparent from the figures and from the description that follows.

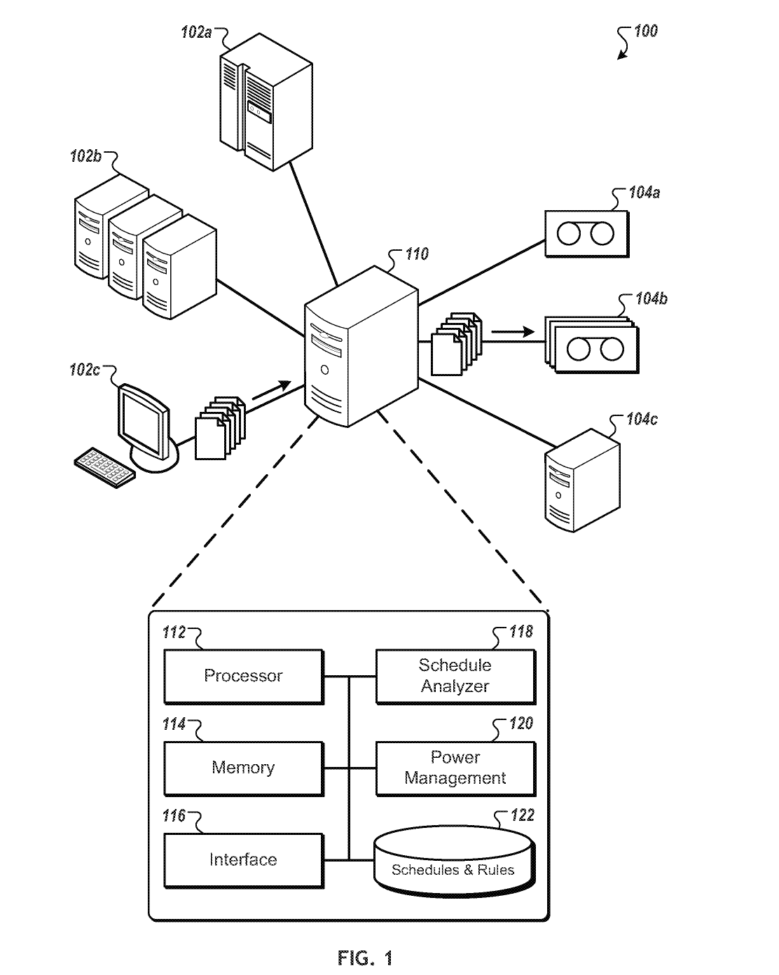

FIG. 1 shows a conceptual diagram of an example backup environment 100. Environment 100 may include multiple source devices 102a, 102b, and 102c, and may also include multiple backup storage devices 104a, 104b, and 104c. The multiple source devices 102a-102c may be communicatively coupled to the multiple backup storage devices 104a-104c via a backup management computing device 110, which may generally be configured to control and manage backup and restore operations. The various devices in environment 100 may be interconnected through one or more appropriate networks. The example topology of environment 100 may provide data backup capabilities representative of various backup environments. However, it should be understood that the example topology is shown for illustrative purposes only, and that various modifications may be made to the configuration. For example, backup environment 100 may include different or additional components, or the components may be connected in a different manner than is shown.

Source devices 102a-102c need not all be of the same type. Indeed, in many environments, source devices 102a-102c will typically vary in type. For example, in an enterprise environment, source devices 102a-102c might take the form of database server dusters, application servers, content servers, email servers, workstations, desktop computers, laptop computers, and the like. Similarly, backup storage devices 104a-104c may vary in type. For example, backup storage devices 104a-104c may include disk devices, tape devices, and/or tape libraries. Other appropriate types of backup storage devices may also be used.

In some environments, a source agent component may execute on each of the source devices 102a-102c, and a media agent component may execute on the backup management computing device 110. The source agent component may be responsible for reading the data from the host device as specified in a backup policy. The data to be backed up may include specific files, file systems, databases, email/file/web servers, or any other appropriate type of data. The media agent component may be responsible for accepting the data from the source agent component and writing it to a destination backup storage device and/or backup medium. In the example shown, data from source device 102c is being backed up to backup storage device 104b via the backup management computing device 110.

As shown, the backup management computing device 110 may include a processor 112, a memory 114, an interface 116, a schedule analyzer 118, a power management module 120, and a repository 122 that stores various schedules and power management rules. It should be understood that the components shown here are for illustrative purposes, and that in some cases, the functionality being described with respect to a particular component may be performed by one or more different or additional components. Similarly, it should be understood that portions or all of the functionality may be combined into fewer components than are shown.

Processor 112 may be configured to process instructions for execution by the backup management computing device 110. The instructions may be stored on a non-transitory tangible computer-readable storage medium, such as in memory 114 or on a separate storage device (not shown), or on any other type of volatile or non-volatile memory that stores instructions to cause a programmable processor to perform the techniques described herein. Alternatively or additionally, backup management computing device 110 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Interface 116 may be implemented in hardware and/or software, and may be configured, for example, to receive and respond to requested backup or restore operations. For example, interface 116 may be configured to receive data to be backed up from a source device, and may be configured to process and/or forward the data to be backed up to an appropriate backup storage device.

Interface 116 may also provide a user interface, such as a graphical user interface (GUI), that allows a backup administrator to define various backup schedules and/or power management rules. For example, the backup administrator may define backup schedules that specify the source of data to be backed up, a schedule for performing backups of that source, the type of backups to be performed, as well as any other appropriate information, such as the backup storage device (or devices) to which the data is to be backed up. Examples of the types of backups to be performed may include full backups (where all of the selected data from a particular source is backed up), cumulative incremental backups (where all changes since the last full backup are backed up), differential incremental backups (where only the portions changed since the last full or cumulative incremental backup are backed up), or other appropriate types of backups. Some backup schedules may include a combination of these backup types (e.g., full backups on the weekend, followed by daily cumulative incremental backups during the week). The schedules may be stored in repository 122.

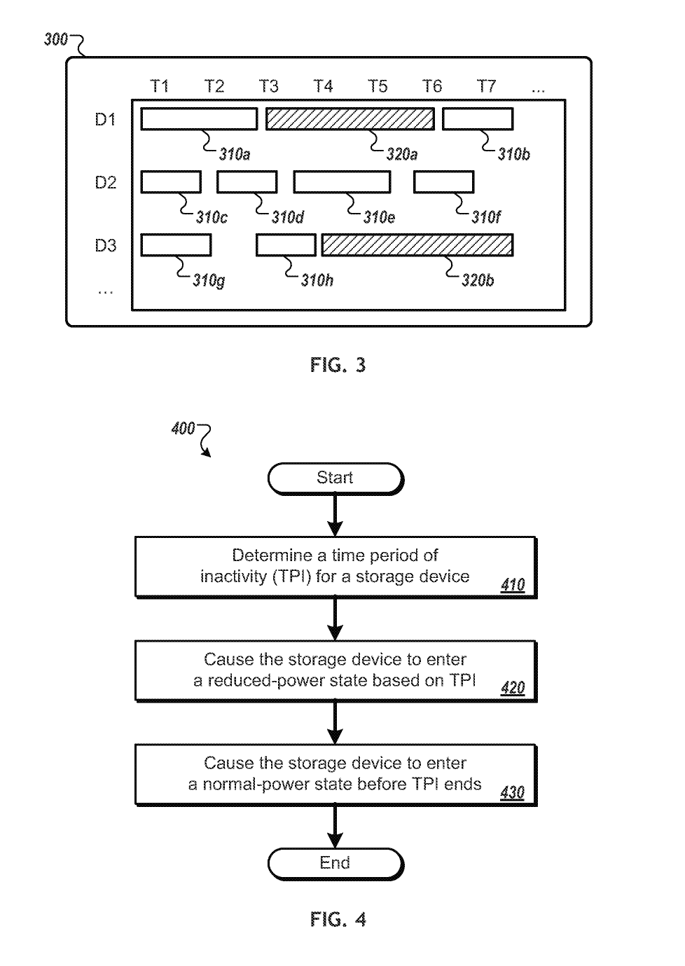

Schedule analyzer 118 may execute on processor 112, and may be configured to determine time periods of inactivity associated with a particular storage device or group of storage devices. For example, the schedule analyzer 118 may analyze one or more schedules stored in repository 122 to determine when backup operations are scheduled to be performed on the particular storage device or group of storage devices. The periods of time during which backup operations are not scheduled to be performed on a particular storage device (e.g., the time periods between the scheduled backup operations) correspond to the time periods of inactivity for the particular storage device. An example backup schedule showing determined time periods of inactivity for a storage device is shown in FIG. 3.

Power management module 120 may execute on processor 112, and may be configured to cause the storage device to enter a reduced-power state based on the time periods of inactivity determined by schedule analyzer 118. For example, at or near the beginning of a time period of inactivity, the power management module 120 may cause power to be completely removed from the storage device, thus causing a cut-power state for the storage device. In such a case, the storage device would not consume any power until the power is subsequently restored. In some cases, before removing power from the storage device, the power management module 120 may cause the storage device to perform any appropriate shutdown tasks, such as parking the heads of disk or tape devices, removing loaded media, and/or performing other appropriate tasks to ensure that the storage device is adequately prepared to be safely powered down.

As another example, rather than removing power from the storage device, the power management module 120 may cause the device to enter a sleep mode, hibernation mode, or other appropriate reduced-power state. While the storage device would still consume some power during the time period of inactivity in such a reduced-power state, the amount of power consumed would be less than if the storage device was allowed to simply remain idle in a normal-power state.

Depending on the various scheduled backup operations, the time periods of inactivity determined by schedule analyzer 118 may be relatively short or relatively long. In some implementations, only time periods of inactivity that are of a sufficient length may be considered when enabling the power-reduction techniques described here. In such cases, whether a time period of inactivity is of sufficient length may be specific to a particular implementation, and/or may be user-configurable, e.g., by a backup administrator. For example, the interface 116 may provide a GUI that allows a backup administrator to configure a rule that only enables the power-reduction techniques for periods of inactivity that are longer than a threshold value (e.g., two hours, three hours, or any other appropriate minimum period of inactivity). Such a rule and the associated threshold value may be stored in repository 122, and may cause the schedule analyzer 118 and/or the power management module 120 to ignore any periods of inactivity that are shorter than the threshold value.

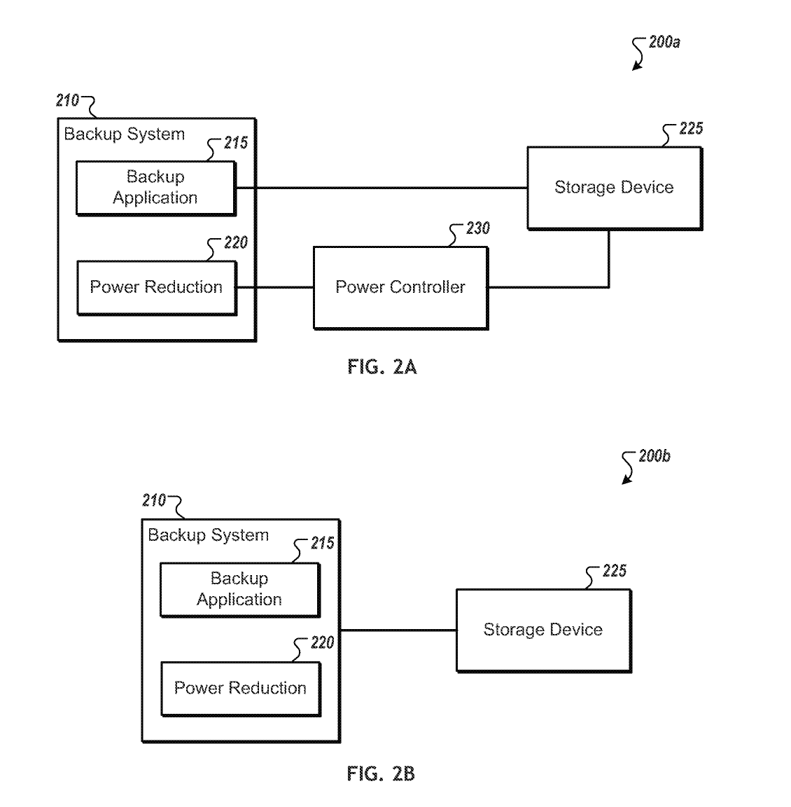

FIGS. 2A and 2B show block diagrams of example backup environments 200a and 200b, respectively. Environments 200a and 200b are intended to provide alternative representations of environment 100 shown in FIG. 1. These alternative representations are for illustrative purposes only, and it should be understood that other alternatives may also be used in accordance with the techniques described herein.

In environments 200a and 200b, a backup system 210 includes a backup application 215 and a power reduction module 220. The backup system 210 may be configured to perform similar functionality to the backup management computing device 110. For example, the backup system 210 may generally be configured to control and manage backup and restore operations associated with storage device 225 (e.g., using backup application 215). In general, environments 200a and 200b primarily differ in how backup system 210 interacts with storage device 225.

The power reduction module 220 in environments 200a and 200b may represent the various components that provide the power-reduction capabilities introduced in FIG. 1. For example, the power reduction module 220 may perform all or portions of the functionality of the schedule analyzer 118, power management module 120, and/or repository 122. As such, power reduction module 220 may be configured to determine a time period of inactivity during which backup operations are not scheduled to be performed on storage device 225, and may cause storage device 225 to enter a reduced-power state based on the determined time period of inactivity.

In environment 200a, power reduction module 220 interacts with a power controller 230, which in turn causes storage device 225 to enter a reduced-power state. In some implementations, power controller 230 may be physically separate from backup system 210 and storage device 225. In some cases, power controller 230 may include a networked power distribution unit (PDU) that is communicatively coupled to the power reduction module 220 and operatively coupled to storage device 225. The PDU may be configured to provide power to one or more storage devices or groups of storage devices. In some implementations, the PDU may provide power-switching capabilities that allow power to be switched on or off individually to each of the storage devices to which the PDU is connected, or to various groups or combinations of storage devices to which the PDU is connected.

In environment 200a, the power reduction module 220 may cause storage device 225 to enter a reduced-power state (e.g., a cut-power state) by issuing an appropriate message to power controller 230, which in turn will remove power from the storage device 225. In such a manner, the storage device 225 will consume less power than if it was left in an idle state during the periods of inactivity when no backup operations were scheduled to be performed on the device.

In environment 200b, the backup system 210 may cause the storage device 225 to enter a reduced-power state directly rather than via the power controller 230 as was described in environment 200a. In environment 200b, the power reduction module 220 may be configured to communicate with storage device 225 using an appropriate messaging protocol. One example of an appropriate messaging protocol may be an extension to the Storage Management Initiative Specification (SMI-S), which generally allows for the interoperable management of a heterogeneous Storage Area Network (SAN).

The messaging protocol (e.g., SMI-S or other appropriate protocol) may allow power reduction module 220 to issue various messages and/or commands to storage device 225. For example, the messaging protocol may include messages that allow the power reduction module 220 to query the current power status of storage device 225, to query an activity status of storage device 225, to request that storage device 225 power down or otherwise enter a reduced-power state (e.g., a sleep mode, hibernation mode, power-saving mode, etc.), and/or to request that storage device 225 power up or otherwise enter a normal-power state.

In response to determining that a time period of inactivity is approaching for storage device 225, power reduction module 220 may communicate with storage device 225 and cause the storage device 225 to enter an appropriate reduced-power state. For example, in some implementations, the power reduction module 220 may issue a message to storage device 225 requesting that the storage device power down or to otherwise enter a reduced-power state. In some cases, before requesting the storage device 225 to enter the reduced-power state, the power reduction module 220 may verify that the storage device is inactive (e.g., that it is not performing any backup or restore operations or any other actions), such as by issuing a query to the storage device 225. Then, when the time period of inactivity is nearing an end, the power reduction module 220 may communicate with storage device 225 to cause the storage device to re-enter a normal-power state.

FIG. 3 shows a conceptual diagram of an example backup schedule 300 with determined time periods of inactivity 320a and 320b. In some implementations, backup schedule 300 may be stored in a database or other repository that is accessible by schedule analyzer 118, such as repository 122 illustrated in FIG. 1.

Backup schedule 300 may be representative of a single backup schedule associated with a particular storage device or group of storage devices, or may be representative of a consolidated schedule of multiple backup schedules. For example, schedule analyzer 118 may analyze a plurality of backup schedules associated with a particular storage device to determine when backup operations are scheduled to be performed on the storage device, and may generate a consolidated backup schedule for the storage device.

As shown in backup schedule 300, a number of backup operations 310a, 310b, 310c, 310d, 310e, 310f, 310g, and 310h are scheduled to be performed at various days and times. The time periods when no backup operations are scheduled to be performed may be considered time periods of inactivity. In some cases, the time periods between backup operations are relatively short (e.g., between backup operation 310c and 310d). In some implementations, such relatively short time periods may be ignored. However, in other cases, the time periods between backup operations are relatively long (e.g., between backup operation 310a and 310b). These time periods of inactivity may be representative of periods that may be identified, e.g., by schedule analyzer 118, as periods during which the storage device should be caused to enter a reduced-power state.

FIG. 4 shows a flow diagram of an example process 400 for causing a storage device to enter a reduced-power state. The process 400 may be performed, for example, by a backup management system, such as backup management computing device 110 illustrated in FIG. 1. For clarity of presentation, the description that follows uses the backup management computing device 110 as the basis of an example for describing the process. However, it should be understood that another system, or combination of systems, may be used to perform the process or various portions of the process.

Process 400 begins at block 410, in which a time period of inactivity is determined for a storage device. For example, the backup management computing device 110 may analyze a plurality of backup schedules associated with the storage device to determine when backup operations are scheduled to be performed on the storage device. The time periods between such scheduled backup operations may be considered time periods of inactivity.

Process 400 continues at block 420, in which the storage device is caused to enter a reduced-power state based on the determined time period of inactivity. For example, in some implementations, the backup management computing device 110 may cause a power controller that provides power to the storage device to remove power from the storage device, e.g., by issuing an appropriate command to the power controller. In other implementations, the backup management computing device 110 may issue an appropriate message to the storage device, the message requesting that the storage device power down or otherwise enter a reduced-power state. In yet other implementations, the backup management computing device 110 may issue a message to the storage device that indicates the determined time period of inactivity, and requesting that the storage device act accordingly, e.g., by implementing its own power management protocols given the time period of inactivity indicated by the message.

Process 400 continues at block 430, in which the storage device is caused to enter a normal-power state before the time period of inactivity ends. For example, in some implementations, the backup management computing device 110 may cause a power controller to restore power to the storage device, e.g., by issuing an appropriate command to the power controller. In other implementations, the backup management computing device 110 may issue an appropriate message to the storage device, the message requesting that the storage device power up or otherwise enter a normal-power state. In yet other implementations, the initial message indicating the determined time period of inactivity may be used by the storage device to restore itself into a normal-power state, e.g., at an appropriate amount of time before the time period of inactivity ends, as indicated by the message.

In some implementations, process 400 may include an optional block (not shown) before block 420, in which the storage device is verified to be inactive before causing the storage device to enter the reduced-power state. For example, the backup management computing device 110 may issue a command (e.g., a lock command) to the storage device, which if denied, may indicate that the storage device is active (e.g., performing tasks that are not defined in the schedule). As another example, the backup management computing device 110 may query the status of the storage device using an appropriate messaging protocol to determine whether the device is active or inactive before causing the storage device to enter the reduced-power state.

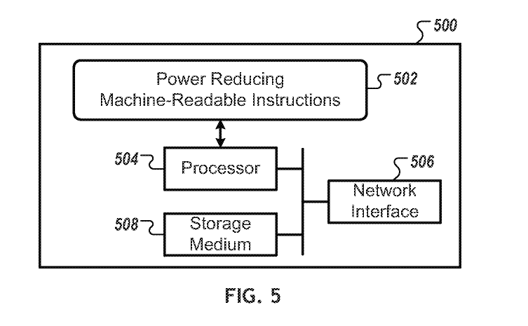

FIG. 5 shows a block diagram of an example system 500, which may be representative of the computing devices of FIG. 1. The system 500 includes power reducing machine-readable instructions 502, which may include certain of the various modules of the computing devices depicted in FIG. 1. The power reducing machine-readable instructions 502 are loaded for execution on a processor or processors 504. A processor can include a microprocessor, microcontroller, processor module or subsystem, programmable integrated circuit, programmable gate array, or another control or computing device. The processor(s) 504 can be coupled to a network interface 506 (to allow the system 500 to perform communications over a data network) and a storage medium (or storage media) 508.

The storage medium 508 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other appropriate types of storage devices. Note that the instructions discussed above can be provided on one computer-readable or machine-readable storage medium, or alternatively, can be provided on multiple computer-readable or machine-readable storage media distributed in a system having possibly plural nodes. Such computer-readable or machine-readable storage medium or media is (are) considered to be part of an article (or article of manufacture). An article or article of manufacture can refer to any appropriate manufactured component or multiple components. The storage medium or media can be located either in the machine running the machine-readable instructions, or located at a remote site, e.g., from which the machine-readable instructions can be downloaded over a network for execution.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A computer-implemented method comprising:
determining, using a backup computing system, a time period of inactivity during which backup operations are not scheduled to be performed on a storage device; and
causing, using the backup computing system, the storage device to enter a reduced-power state based on the determined time period of inactivity.

2. The computer-implemented method of claim 1, wherein determining the time period of inactivity comprises analyzing a plurality of backup schedules associated with the storage device to determine when backup operations are scheduled to be performed on the storage device.

3. The computer-implemented method of claim 1, wherein causing the storage device to enter the reduced-power state comprises causing a power controller that provides power to the storage device to remove power from the storage device.

4. The computer-implemented method of claim 1, wherein causing the storage device to enter the reduced-power state comprises issuing a message to the storage device, the message requesting that the storage device power down.

5. The computer-implemented method of claim 1, further comprising verifying that the storage device is inactive before causing the storage device to enter the reduced-power state.

6. The computer-implemented method of claim 1, further comprising, after the storage device has been caused to enter the reduced-power state, causing the storage device to enter a normal-power state before the time period of inactivity ends.

7. A system comprising:
a storage device; and
a backup computing system that executes backup operations to store backup data on the storage device according to a schedule, and causes the storage device to operate in a reduced-power state during a period of time when no backup operations are scheduled to be performed on the storage device.

8. The system of claim 7, wherein the backup computing system analyzes a plurality of backup schedules associated with the storage device to determine when no backup operations are scheduled to be performed on the storage device.

9. The system of claim 7, further comprising a power controller that provides power to the storage device, wherein the backup computing system causes the storage device to operate in the reduced-power state by causing the power controller to remove power from the storage device.

10. The system of claim 7, wherein the backup computing system causes the storage device to operate in the reduced-power state by issuing a message to the storage device, the message requesting that the storage device power down.

11. The system of claim 7, wherein the backup computing system verifies that the storage device is inactive before causing the storage device to operate in the reduced-power state.

12. The system of claim 7, wherein the backup computing system causes the storage device to operate in a normal-power state during a period of time when backup operations are scheduled to be performed on the storage device.

13. A non-transitory, computer-readable medium storing instructions that, when executed by one or more processors, cause the one or more processors to:
determine a time period of inactivity during which backup operations are not scheduled to be performed on a storage device; and
cause the storage device to operate in a reduced-power state during the determined time period of inactivity.

14. The non-transitory, computer-readable medium of claim 13, further comprising instructions that cause the one or more processors to verify that the storage device is inactive before causing the storage device to operate in the reduced-power state.

15. The non-transitory, computer-readable medium of claim 13, further comprising instructions that cause the one or more processors to cause the storage device to operate in a normal-power state outside the time period of inactivity.
